(19) United States
(12) Patent Application Publication
(10) Pub. No.: US 2025/0385515 A1
(43) Pub. Date: Dec. 18, 2025

(54) MULTI-PORT DC TRANSFER SWITCH BASED ON CONTROLLABLE NEGATIVE VOLTAGE SOURCE

(71) Applicants: China Southern Power Grid Company Limited EHV Transmission Company, Guangzhou (CN); Tianjin University, Tianjin (CN)

(72) Inventors: Wenjie Wen, Tianjin (CN); Changhong Zhang, Guangzhou (CN); Xiaoxia Huang, Tianjin (CN); Jinghan Fan, Tianjin (CN); Bin Li, Tianjin (CN); Xu Wang, Tianjin (CN); Weiguo Li, Guangzhou (CN); Mingyang Li, Guangzhou (CN); Xu Yang, Guangzhou (CN)

(73) Assignees: China Southern Power Grid Company Limited EHV Transmission Company, Guangzhou (CN); Tianjin University, Tianjin, TJ (CN)

(21) Appl. No.: 19/315,554

(22) Filed: Aug. 30, 2025

(30) Foreign Application Priority Data
Apr. 30, 2025 (CN) 202510561326.X

(51) Int. Cl. H02J 1/00; H02J 3/36

(52) U.S. Cl. CPC H02J 1/00; H02J 3/36

(57) ABSTRACT

The invention discloses a multi-port DC transfer switch based on a controllable negative voltage source, which belongs to the technical field of power equipment. It includes X (X=5 or 3) main branches, a current commutation branch and X groups of controllable conduction switches. The main branch is composed of through-current vacuum switch, and the current commutation branch is composed of a controllable negative voltage source and a square wave resonant DC circuit breaker in series. The five main branches at the sending terminal are connected to the positive rectifier at the sending terminal, etc., and the three main branches at the receiving terminal are connected to the positive rectifier at the receiving terminal, etc., which are connected to the current commutation branch through the controllable conduction switches.

### TECHNICAL FIELD

The invention relates to the technical field of power equipment, in particular to a multi-port direct current (DC) transfer switch based on a controllable negative voltage source.

### BACKGROUND

In order to ensure the stability, safety and efficiency of the system, it is necessary to complete the switching of the system operation mode in the high-voltage direct current transmission system based on line-commutated converters (LCC-HVDC) through the coordination of the DC transfer switch and the isolation switch under the condition of the fault of the converter valve or the DC line, the maintenance of the DC line and the change of the system power demand.

As shown in FIG. 1, the conventional DC transfer switch is a two-port switch, which consists of a load current path, a current commutation path and an energy absorption path. The load current path is composed of mechanical switches; the current commutation path is composed of LC oscillation circuit. The energy absorption path is composed of arrester groups. The working process of the DC transfer switch is as follows: responding to the separating brake signal, the mechanical switch contacts are separated, the arc is generated between the contacts, and the arc resistance presents a nonlinear change; due to the negative impedance characteristics of the arc, the oscillating current in the LC circuit diverges and oscillates. When the sum of the load current and the oscillating current superimposed on the load current path passes across zero, the arc of the mechanical switch is extinguished, and the load current is transferred to the current commutation path. The load current charges the capacitor C, when the voltage at both ends of the arrester rises to the operating voltage of the arrester, the arrester acts, and the load current is transferred to the energy absorption path. The arrester absorbs energy, the load current is reduced to zero, and the current transfer is completed.

Since the DC transfer switch is a two-port switch, and the LCC-HVDC transmission system has a variety of necessary operation mode switching requirements, it is necessary to reinstall multiple DC transfer switches in the system to achieve different operation mode switching requirements. As shown in FIG. 2, according to the different lines connected to the port, the DC transfer switch in the LCC-HVDC transmission project is subdivided into metallic return transfer breaker MRTB, earth return transfer breaker ERTB, neutral bus switch NBS and neutral bus ground switch NBGS.

The ports of the MRTB are connected to the neutral bus at the sending terminal and the grounding electrode at the sending terminal, respectively. The main function is to transfer the load current from the ground return line with lower impedance to the positive/negative metallic return line with higher impedance, and complete the switching from the ground return operation mode to the metallic return operation mode. The ports of the ERTB are connected to the neutral bus at the sending terminal and the positive and negative metallic return lines respectively. The main function is to convert the load current from the positive/negative metallic return line to the ground return line, so as to complete the switching from the metallic return operation mode to the ground return operation. The ports of NBS1 are connected to the neutral bus at the sending terminal and the rectifier connected to the positive metallic return line respectively. The ports of NBS2 are connected to the neutral bus at the sending terminal and the rectifier connected to the negative metallic return line respectively. The ports of NBS3 are connected to the neutral bus at the receiving terminal and the inverter connected to the positive metallic return line respectively. The ports of NBS4 are connected to the neutral bus at the receiving terminal and the inverter connected to the negative metallic return line respectively. The main functions of NBS1, NBS2, NBS3 and NBS4 are as follows: after the rectifier or inverter is blocked, NBS switches off to realize the switching from bipolar operation mode to ground return operation mode. The ports of NBGS1 are connected to the neutral bus at the sending terminal and the grounding grid at the sending terminal respectively, and the ports of NBGS2 are connected to the neutral bus at the receiving terminal and the grounding grid at the receiving terminal respectively. The main function of NBGS is that when the grounding electrode line fails, NBGS closing provides a grounding point for the DC system, so that the positive and negative unbalanced current flows through the grounding grid.

In summary, the LCC-HVDC transmission system relies on two-port DC transfer switches (such as metallic return transfer breaker MRTB and earth return transfer breaker ERTB) to achieve operation mode switching. Such switches mostly use sulfur hexafluoride (SF₆) gas as the arc extinguishing medium, and there are the following problems:

Poor environmental protection: SF₆ is a strong greenhouse gas, which is harmful to the environment after leakage;
bulky equipment: the frequency of the LC resonant circuit is low (<5 kHz), which requires large capacity capacitors and reactors, resulting in a large volume;
high cost: multiple independent two-port switches need to be configured to meet different switching requirements, and the arrester needs to absorb a lot of energy, which is expensive.

In the existing technology, the DC transfer switch of ABB and other manufacturers relies on the negative resistance characteristics of SF₆ arc to realize current transfer, but its medium recovery speed is limited, which makes it difficult to meet the demand of high frequency. In addition, the lack of multi-port switches leads to the need to configure multiple independent switches in the system, which occupies a large area and is complicated to control.

### SUMMARY

The purpose of the invention is to provide a multi-port DC transfer switch based on a controllable negative voltage source, by sharing the current commutation branch and the controllable conduction switches, the problems of bulky equipment, high cost and poor environmental protection in the existing technology are solved.

In order to achieve the above purpose, the invention provides a multi-port DC transfer switch based on a controllable negative voltage source, including X main branches, a current commutation branch and X group controllable conduction switches, where X=5 or 3, X main branches are composed of a through-current vacuum switch, and the current commutation branch is composed of a controllable negative voltage source and a square wave resonant DC circuit breaker in series.

In some embodiments, the multi-port DC transfer switch in a sending terminal of a conventional DC transmission system has five main branches, a main branch 1, a main branch 2, a main branch 3, a main branch 4 and a main branch 5 of the five main branches are electrically connected to a positive rectifier at the sending terminal, a grounding electrode at the sending terminal, a grounding grid at the sending terminal, a positive/negative metallic return line, a negative converter at the sending terminal and a neutral bus at the sending terminal respectively. The current commutation branch is connected to the neutral bus at the sending terminal; remote-bus terminals of the five main branches are connected to a remote-bus terminal of the current commutation branch through a set of controllable conduction switches.

In some embodiments, the multi-port DC transfer switch at a receiving terminal of the conventional DC transmission system has three main branches, among the three main branches, the main branch A, the main branch B and the main branch C are electrically connected to the positive rectifier at the receiving terminal, the grounding grid at the receiving terminal, the negative converter at the receiving terminal, and a neutral bus at the receiving terminal respectively. The current commutation branch is connected to the neutral bus of the receiving terminal; remote-bus terminals of the three main branches are connected to the remote-bus terminal of the current commutation branch through a set of controllable conduction switches.

In some embodiments, the controllable negative voltage source includes two parallel connected double thyristor branches and one negative voltage source, when the current on a main branch needs to be transferred, the negative voltage source is cut into a current commutation branch by triggering the thyristor to realize a transfer of a load current, a first double thyristor branch is composed of thyristor VT₁ and thyristor VT₂ co-cathode in series, and a second double thyristor is composed of thyristor VT₃ and thyristor VT₄ co-anode in series, an anode of the thyristor VT₁ and a cathode of the thyristor VT₃ are connected, and a terminal is drawn from the connection, which is a near-bus terminal of the controllable negative voltage source; an anode of the thyristor VT₂ and a cathode of the thyristor VT₄ are connected, and a terminal is drawn from the connection, which is a remote-bus terminal of the controllable negative voltage source; the negative voltage source is composed of a pre-charged capacitor and a diode component in reverse parallel, a function of the diode component is to provide a path for the load current after the current is transferred to the current commutation branch, a negative electrode of a pre-charged capacitor is connected to a common cathode point of the first double thyristor branch, and a positive electrode of the pre-charged capacitor is connected to a common anode point of a second double thyristor branch.

In some embodiments, the square wave resonant DC circuit breaker includes a temporary current branch, an LC branch and a MOV branch connected in parallel;

The temporary current branch is composed of a vacuum switch for current transfer and a controllable square wave voltage source in series, which is used to transfer the load current of the main branch; the LC branch is composed of a reactor and a capacitor in series, which is used to generate an oscillating current to make the current on the temporary current branch pass zero; the MOV branch is composed of metal zinc oxide arresters, which are used to absorb energy and establish transient voltage to transfer load current to other main branches.

In some embodiments, the controllable square wave voltage source is composed of a trigger branch, a clamping branch and a buffer branch in parallel, the trigger branch is composed of n switch branches (n=1,2,3 . . . ) in parallel to realize a continuous switching of the on-state and off-state of the trigger branch at a predetermined frequency; the buffer branch is composed of a resistor and a capacitor in series; when the trigger branch is turned off, the load current is transferred to the buffer branch to charge the capacitor, so that voltage at both ends of the clamping branch rises rapidly to an operating voltage of the arrester; the clamping branch is composed of metal zinc oxide arresters. When the trigger branch is turned off, the clamping branch can maintain an output voltage of the controllable square wave voltage source equal to a residual voltage of the arrester; the i-th switching branch (i=1, 2, 3, . . . , n) is composed of two IGBT components in series. The IGBT at the near-bus terminal is IGBT_{fi}, and the IGBT at the far-bus terminal is IGBT_{bi}. Each IGBT component is reversely connected in parallel with a diode to achieve bidirectional current flow of a trigger branch; the IGBTs of all near-bus terminals on n switching branches are IGBT_{f}, and the IGBTs of all far-bus terminals are IGBT_{b}.

In some embodiments, the controllable conduction switch may be composed of a thyristor component, when the thyristor component is used to connect the main branch 2, the main branch 3, the main branch 4 and a current commutation branch, a two-way conduction structure is adopted; when the thyristor component is used to connect the main branch 1, the main branch 5 and the current commutation branch, only an one-way conduction structure is adopted; when the thyristor component is used to connect main branch B and the current commutation branch, a two-way conduction structure is adopted; when the thyristor component is used to connect the main branch A, the main branch C and the current commutation branch, only an one-way conduction structure is adopted. The two-way conduction structure is formed by connecting two thyristor components in reverse parallel. The thyristor component whose conduction direction is consistent with a current direction of a neutral bus of the sending/receiving terminal through the current commutation branch is a forward thyristor component, and the thyristor component whose conduction direction is opposite to a current direction of the neutral bus of the sending/receiving terminal through the current commutation branch is a reverse thyristor component. The one-way conduction structure is a thyristor component, the thyristor component connecting the main branch 1 and the main branch C is a forward thyristor component, and the thyristor component connecting the main branch 5 and the main branch A is a reverse thyristor component.

In some embodiments, the controllable conduction switch may be composed of a vacuum trigger gap, when the vacuum trigger gap is used to connect the main branch 2, the main branch 3, the main branch 4 and the current commutation branch, a two-way conduction structure is adopted; when the vacuum trigger gap is used to connect the main branch 1, the main branch 5 and the current commutation branch, only an one-way conduction structure is adopted; when the vacuum trigger gap is used to connect the main branch B and the current commutation branch, a two-way conduction structure is adopted; when the vacuum trigger gap is used to connect the main branch A, the main branch C and the current commutation branch, only an one-way conduction structure is adopted, a two-way conduction structure is formed by connecting two vacuum trigger gaps in reverse parallel. The vacuum trigger gap whose conduction direction is consistent with the current direction of the neutral bus through the current commutation branch in the sending/receiving terminals is a forward vacuum trigger gap. The vacuum trigger gap whose conduction direction is opposite to the current direction of the neutral bus through the current commutation branch at the sending/receiving terminals is a reverse vacuum trigger gap. The one-way conduction structure is a vacuum trigger gap. The vacuum trigger gap connecting the main branch 1 and the main branch C is a forward vacuum trigger gap. The vacuum trigger gap connecting the main branch 5 and the main branch A is a reverse vacuum trigger gap.

Therefore, the invention adopts a multi-port DC transfer switch based on a controllable negative voltage source with the above structure, which has the following beneficial effects:

The invention can transfer the load current of multiple main branches by sharing the current commutation branch and the controllable conduction switch, and a square wave resonant DC circuit breaker is used to quickly transfer the load current to other main branches to complete the operation mode switching, which reduces the use of high-voltage capacitors, metal arresters and other high-cost equipment, and greatly reduces the cost of DC transfer switch. The controllable negative voltage source is cut into the current commutation branch, which greatly increases the speed of load current transfer to the current commutation branch, reduces the performance requirements of the vacuum switch on the main branch, and reduces the cost of the DC transfer switch. Using vacuum switch instead of sulfur hexafluoride switch as the main switch of square wave resonant DC circuit breaker has the advantage of green environmental protection. The controllable square wave voltage source is used to make the oscillation current of LC branch diverge and oscillate, which further reduces the cost of high voltage capacitors and high voltage reactors.

The following is a further detailed description of the technical scheme of the invention through drawings and implementation examples.

### BRIEF DESCRIPTION OF THE DRAWINGS

FIG. 1 is a topology diagram of the existing conventional DC transfer switch;

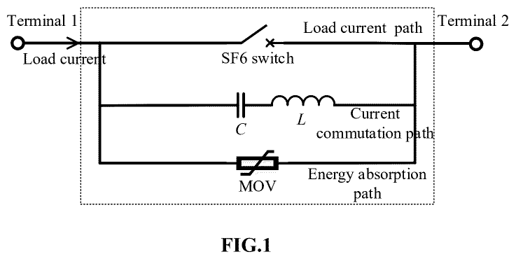

FIG. 2 is a schematic diagram of the configuration scheme of the conventional DC transfer switch in the existing conventional DC transmission system.

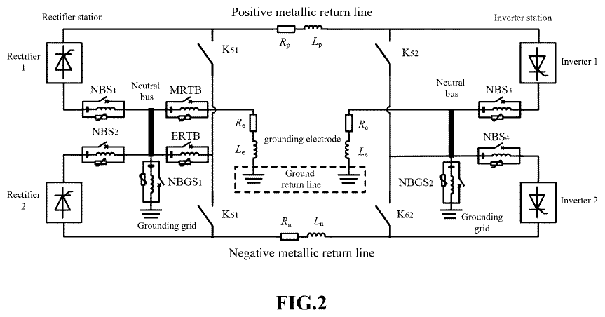

FIG. 3 is a schematic diagram of the topological structure of the multi-port DC transfer switch based on the controllable negative voltage source and its connection with the sending/receiving line of the conventional DC transmission system.

FIG. 4 is a schematic diagram of the current commutation branch line connection of the embodiment of the invention;

FIG. 5 is a schematic diagram of the controllable square wave voltage source line connection of the embodiment of the invention.

### DETAILED DESCRIPTION OF THE EMBODIMENTS

The following is a further explanation of the technical scheme of the invention through drawings and implementation examples.

Unless otherwise defined, the technical terms or scientific terms used in the invention should be understood by people with general skills in the field to which the invention belongs. The words ‘first’, ‘second’, and the like used in this invention do not represent any order, quantity, or importance, but are only used to distinguish different components. Similar words such as ‘include’ or ‘including’ mean that the elements or objects appearing before the word cover the elements or objects listed after the word and their equivalents, without excluding other elements or objects. Similar terms such as ‘connecting’ or ‘connected’ are not limited to physical or mechanical connections, but can include electrical connections, whether direct or indirect. ‘Up’, ‘down’, ‘left’, ‘right’, etc. are only used to represent the relative positional relationship. When the absolute position of the described object changes, the relative positional relationship may also change accordingly.

### Example 1

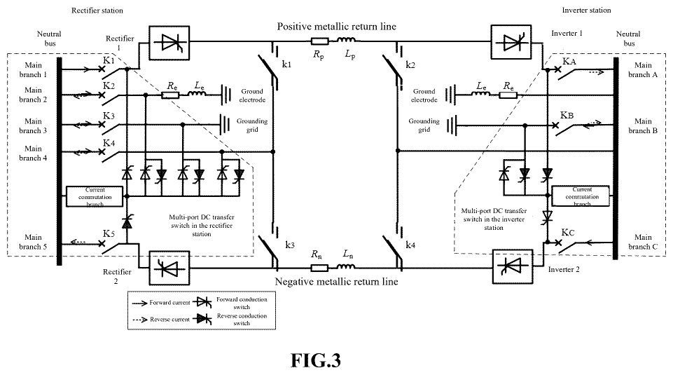

As shown in FIG. 3, a topology of multi-port DC transfer switch based on a controllable negative voltage source and its connection mode in a conventional DC transmission system.

The multi-port DC transfer switch at the sending terminal includes five main branches, a current commutation branch and controllable conduction switches. The main branch 1, the main branch 2, the main branch 3, the main branch 4 and the main branch 5 are connected in turn to the positive rectifier 1, the grounding electrode, the grounding grid, the positive/negative metallic return line, the negative rectifier 2 and the neutral bus at the sending terminal. Each of the five main branches consists of a through-flow vacuum switch. The current commutation branch is connected to one end of the main branch through the bus, and the other end is connected to the controllable conduction switch (in this example, take the controllable conduction switch composed of thyristor components as an example). Because the current direction of the grounding electrode, grounding grid and positive/negative metallic return line is not unique, the controllable conduction switch connecting the main branch 2, the main branch 3 and the main branch 4 is composed of two thyristor components in reverse parallel. Since the current of the positiverectifier 1 is always the forward current (flowing out from the bus), the controllable conduction switch connected to the main branch 1 is a forward conduction switch; since the current of the negative rectifier 2 is always the reverse current (flowing to the bus), the controllable conduction switch connected to the main branch 5 is a reverse conduction switch.

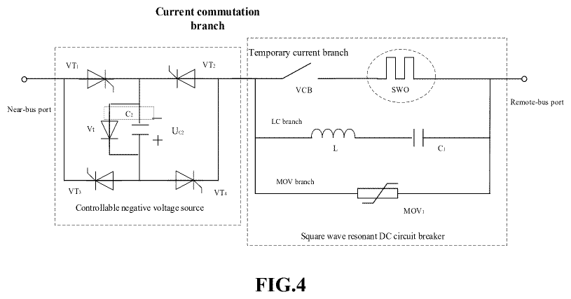

As shown in FIG. 4, the current commutation branch is composed of a controllable negative voltage source and a square wave resonant DC circuit breaker. The controllable negative voltage source is composed of a pre-charged capacitor C₂, a through-current diode Vt and four thyristor components. The thyristor VT₁ and the thyristor VT₃ are the thyristor components at the near-bus terminal, and the thyristor VT₂ and the thyristor VT₄ are the thyristor components at the far-bus terminal. If the current commutation branch needs to conduct the positive current, the thyristor VT₁ and the thyristor VT₄ are triggered to cut the negative voltage source into the current commutation branch. If the current commutation branch needs to conduct the reverse current, the thyristor VT₂ and the thyristor VT₃ are triggered to cut the negative voltage source into the current commutation branch.

As shown in FIG. 4, the square wave resonant DC circuit breaker consists of a temporary current branch, an LC branch, and a MOV branch. The temporary current branch includes a vacuum switch for current transfer VCB and a controllable square wave voltage source SWO; the LC branch includes a high voltage capacitor C₁ and a high voltage reactor L; the MOV branch includes the arrester MOV₁.

The working process of the square wave resonant DC circuit breaker is as follows: the load current flows through the temporary current branch, the VCB switches off, and the contacts begin to separate. Then, according to the direction of the load current, the controllable square wave voltage source is selectively triggered to make the square wave voltage and the LC resonant frequency meet the same frequency/frequency doubling relationship. The oscillating current begins to generate in the LC branch and gradually diverges. The oscillating current is superimposed on the temporary current branch to extinguish the arc between the VCB contacts. The load current is transferred to the LC branch to charge the capacitor C₁. The voltage at both ends of the MOV branch gradually rises. When the voltage at both ends rises to the operating voltage of MOV₁, MOV₁ acts to establish a transient voltage and absorb energy. The load current is transferred to other main branches.

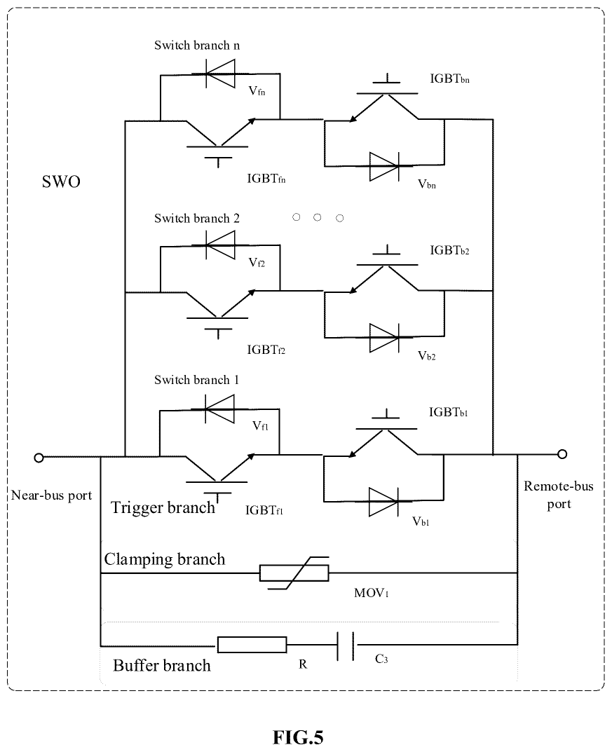

As shown in FIG. 5, the controllable square wave voltage source SWO consists of a trigger branch, a clamping branch, and a buffer branch. The trigger branch is composed of n switch branches in parallel, each switch branch is composed of IGBT_{fi} and IGBT_{bi} (i=1,2,3, . . . , n), and the IGBT_{fi} is connected in parallel with the diode V_{fi}, and the IGBT_{bi} is connected in parallel with the diode V_{bi}; the clamping branch is composed of arrester MOV₁. The buffer branch consists of a resistor R and a capacitor C₃.

The working principle of the controllable square wave voltage source SWO is as follows: the turn-on and turn-off of the IGBT is controlled by the same frequency/fraction frequency control method, so that the frequency of the output voltage U_{SWO} of the square wave voltage source and the resonant frequency of the LC branch satisfy the frequency doubling relationship. When the IGBT is turned on, the load current flows through the trigger branch, and the U_{SWO} is 0. When the IGBT is turned off, the load current is transferred to the buffer branch to charge the capacitor C₃, and the voltage at both ends of the clamping branch rises. When it rises to the operating voltage of MOV₁, MOV₁ acts, and the output voltage of the square wave voltage source U_{SWO} rises to the residual voltage of MOV₁.

When the trigger branch is composed of one switching branch, the same frequency/fraction frequency control method achieves f_{U}_{_{SWO}}/f_{LC}=1/N by reducing the switching frequency of IGBT. The specific implementation method is as follows: firstly, IGBT₁ is turned off and 2N−1 capacitor voltage half-wave is kept in the turn-off state. When the capacitor voltage reaches the N-th positive peak, IGBT₁ is turned on and 1 half-wave is kept in the turn-on state. When the capacitor voltage decreases from the positive voltage peak to the reverse voltage peak, IGBT₁ is turned off again, and it cycles into a

### Example 2

As shown in FIG. 3, the multi-port DC transfer switch at the receiving terminal includes three main branches, a current commutation branch and controllable conduction switches. The main branch A, the main branch B and the main branch C are connected to the positive inverter 1, the grounding grid, the negative inverter 2 and the neutral bus at the receiving terminal in turn. Each of the three main branches is composed of a through-flow vacuum switch. The current commutation branch is connected to one end of the main branch through the bus, and the other end is connected to the controllable conduction switch (in the implementation case, take the controllable conduction switch composed of thyristor components as an example). Since the current direction of the grounding grid is not unique, the controllable conduction switch connecting the main branch B is composed of two thyristor components in reverse parallel. Since the current of the positive inverter 1 is always the reverse current (flow to the bus), the controllable conduction switch connected to the main branch A is the reverse conduction switch; since the current of the negative inverter 2 is always positive current (outflow from the bus), the controllable conduction switch connected to the main branch C is a positive conduction switch. Its working principle is similar to that of the sending terminal, and the efficient transfer of current is realized by a controllable negative voltage source and a square wave resonant DC circuit breaker.

Therefore, the invention adopts a multi-port DC transfer switch based on a controllable negative voltage source of the above structure, and replaces the SF₆ switch with a vacuum switch to eliminate greenhouse gas emissions, which is in line with the trend of green energy. The current commutation branches and arresters are shared, the number of core components such as high-voltage capacitors and reactors are reduced, and reduce equipment costs can be cut down. The controllable square wave voltage source excites the high frequency oscillation of the LC branch, which significantly reduces the volume of the capacitor and inductor. Through the controllable negative voltage source and the same frequency/fraction frequency control method, the rapid transfer of current in different directions is realized, and the response speed of the system is improved.

Finally, it should be explained that the above embodiments are only used to illustrate the technical scheme of the invention rather than restrict it. Although the invention is described in detail with reference to the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A multi-port DC transfer switch based on a controllable negative voltage source, comprising:
X main branches, a current commutation branch and X groups of controllable conduction switches;
wherein X=5 or 3,
wherein the X main branches comprise a through-current vacuum switch, and the current commutation branch comprises a controllable negative voltage source and a square wave resonant DC circuit breaker in series; and
the multi-port DC transfer switch at a sending terminal of a conventional DC transmission system has five main branches,
wherein the main branches are respectively connected to a positive rectifier at the sending terminal, a grounding electrode at the sending terminal, a grounding grid at the sending terminal, a positive/negative metallic return line, a negative converter at the sending terminal and a neutral bus at the sending terminal;
wherein the current commutation branch is connected to the neutral bus at the sending terminal; and
wherein remote-bus terminals of the five main branches are connected to a remote-bus terminal of the current commutation branch through a set of controllable conduction switches;
wherein the multi-port DC transfer switch at a receiving terminal of the conventional DC transmission system has three main branches,
wherein the three main branches are respectively connected to the positive rectifier at the receiving terminal, the grounding grid at the receiving terminal, the negative converter at the receiving terminal, and a neutral bus at the receiving terminal;
wherein a current commutation branch is connected to the neutral bus of the receiving terminal; and
wherein remote-bus terminals of the three main branches are connected to the remote-bus terminal of the current commutation branch through a set of controllable conduction switches.

2. (canceled).

3. (canceled).

4. The multi-port DC transfer switch based on a controllable negative voltage source according to claim 1, wherein:
the controllable negative voltage source comprises two parallel connected double thyristor branches and one negative voltage source;
one of the double thyristor branches is composed of thyristor VT₁ and thyristor VT₂ co-cathode in series, and the other double thyristor is composed of thyristor VT₃ and thyristor VT₄ co-anode in series; and
the negative voltage source is composed of a pre-charged capacitor and a diode component in reverse parallel, a negative electrode of a pre-charged capacitor is connected to a common cathode point of the first double thyristor branch, and a positive electrode of the pre-charged capacitor is connected to a common anode point of a second double thyristor branch.

5. The multi-port DC transfer switch based on a controllable negative voltage source according to claim 1, wherein:
the square wave resonant DC circuit breaker comprises a temporary current branch, a LC branch and a MOV branch connected in parallel;
the temporary current branch is composed of a vacuum switch for current transfer and a controllable square wave voltage source in series;
the LC branch is composed of a reactor and a capacitor in series; and
the MOV branch is composed of metal zinc oxide arresters.

6. The multi-port DC transfer switch based on a controllable negative voltage source according to claim 1, wherein the controllable conduction switch may be composed of a thyristor component or a vacuum trigger gap;
when the current of the main branch is not in one direction, a two-way conduction structure is utilized, wherein the two thyristor components or the vacuum trigger gap are in reverse parallel; and
when the current of the main branch is in one direction, a one-way conduction structure is utilized, comprising a single thyristor component or a vacuum trigger gap.

7. The multi-port DC transfer switch based on a controllable negative voltage source according to claim 5, wherein the controllable square wave voltage source is composed of a trigger branch, a clamping branch and a buffer branch in parallel;
wherein the trigger branch is composed of n switch branches in parallel, wherein n is a positive real number;
the buffer branch is composed of a resistor and a capacitor in series; and
the clamping branch is composed of metal zinc oxide arresters.
